(19) United States
(12) Patent Application Publication
(10) Pub. No.: US 2020/0391122 A1
(43) Pub. Date: Dec. 17, 2020

(54) Online Platform For Simultaneous Multiplayer Video Gaming And Broadcasting

(71) Applicants: Steven Michael Hamilton, San Francisco, CA (US); Michael Quong Kwan, San Francisco, CA (US)

(72) Inventors: Steven Michael Hamilton, San Francisco, CA (US); Michael Quong Kwan, San Francisco, CA (US)

(21) Appl. No.: 16/900,988

(22) Filed: Jun. 14, 2020

Related U.S. Application Data
(60) Provisional application No. 62/861,324, filed on Jun. 14, 2019.

(51) Int. Cl. A63F 13/86; A63F 13/35

(52) U.S. Cl. CPC A63F 13/86; A63F 13/35

(57) ABSTRACT

A method and a combined streaming platform for broadcasting a video game are provided. The combined streaming platform receives a first stream of the video game from a first user device, and a second stream of the video game from a second user device. The first stream and the second stream comprise one or more of an audio and a plurality of images representing a gameplay of the video game. The combined streaming platform creates a video game stream comprising the first stream and the second stream of the video game. The video game stream is configured to be displayed on a viewer device for simultaneously displaying the first stream and the second stream of the video game. The combined streaming platform broadcasts the video game stream to one or more viewer devices.

### CROSS-REFERENCE TO RELATED APPLICATIONS

This application claims priority to and the benefit of the provisional patent application titled “Online Platform For Simultaneous Multiplayer Video Gaming And Broadcasting”, application No. 62/861,324, filed in the United States Patent and Trademark Office on Jun. 14, 2019. The specification of the above referenced patent application is incorporated herein by reference in its entirety.

### BACKGROUND

In recent times, video games have gained popularity among adults and children, and are starting to become as popular as sports. Improvements in computer graphics, computer hardware, etc., have enabled video games to deliver a near real life experience to gamers. However, while the sports industry is supported by various broadcasting technologies, offering live coverage of sports along with commentary as a television program, on radio, and other broadcasting media, the same is not available for video games.

Player v/s Player (PvP) games, for example, League of Legends, Fortnite Battle Royale, etc., have become the most preferred type of multiplayer videogames. In a PvP game, at least one player competes against another player in the video game environment by controlling characters in the game. Viewers can subscribe to a streaming service to stream the player's gameplay on to a display screen of their viewer device. However, if a viewer intends to simultaneously view the gameplays of two or more players, the viewer has to stream the gameplays of the players on to different display screens. Sports broadcasters, for example, ESPN® provide a multicast feature on Apple TV® that allows viewers watch two games side by side or with one full screen and one in picture-in-picture mode, three games tiled with two stacked, four games tiled with three stacked, and four games equally divided into quadrants. However, a similar feature is not available for video game streaming.

Viewers often wish to interact with players who are streaming their gameplay in order to express their opinion, provide gameplay strategies, etc. Often, such gameplay strategies need to be sent to a particular player in private. However, current video game streaming services do not allow a viewer to interact with a particular player in private. Current video game streaming services also do not allow viewers to simultaneously interact with two or more players.

Hence, there is a long felt need for a method and a system for receiving a stream of a video game from a first player and another stream of the video game from the second player and simultaneously broadcasting the streams of both the first player and the second players the same streaming screen of a viewer device for subscribers to view the broadcasted streams simultaneously. There is also a long felt need for a method and a system for providing a chat interface to subscribers for interacting with one or more players simultaneously. There is also a long felt need for a method and a system for providing a chat interface to subscribers for interacting with a player in private mode.

### SUMMARY OF THE INVENTION

This summary is provided to introduce a selection of concepts in a simplified form that are further disclosed in the detailed description of the invention. This summary is not intended to determine the scope of the claimed subject matter.

The method and system disclosed herein address the above recited need for simultaneously broadcasting the streams of a video game received from a first player and a second player to the same streaming screen of a viewer device for subscribers to view the broadcasted streams simultaneously. The method and system disclosed herein also address the above recited need for providing a chat interface to subscribers for interacting with one or more players simultaneously. The method and system disclosed herein also address the above recited need for providing a chat interface to subscribers for interacting with a player in private mode.

The method disclosed herein comprises providing a combined streaming platform comprising a processor and a memory unit communicatively coupled to the processor. The memory unit comprises computer program instructions that when executed by the processor cause the computer to create and broadcast a video game stream comprising a first stream and a second stream. The combined streaming platform receives the first stream of the video game from a first user device. The combined streaming platform also receives the second stream of the video game from a second user device. The first and second streams comprise one or more of audio and images representing a gameplay of the video game. The combined streaming platform creates the video game stream comprising the first stream and the second stream. The video game stream is configured to be displayed on a viewer device for simultaneously displaying the first stream and the second stream. The combined streaming platform broadcasts the video game stream to one or more viewer devices.

In one or more embodiments, related systems comprise circuitry and/or programming for effecting the methods disclosed herein. The circuitry and/or programming can be any combination of hardware, software, and/or firmware configured to effect the methods disclosed herein depending upon the design choices of a system designer. Also, various structural elements can be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a method of creating and broadcasting a video game stream.

FIG. 2 exemplarily illustrates a flowchart showing steps involved in starting a VS mode comprising two players.

FIG. 3 exemplarily illustrates a combined streaming platform, first user device, second user device, and multiple viewer devices.

FIG. 4 illustrates a standard broadcast displayed on the first user device.

FIG. 5 illustrates a display screen of a viewer's user device.

### DETAILED DESCRIPTION OF THE INVENTION

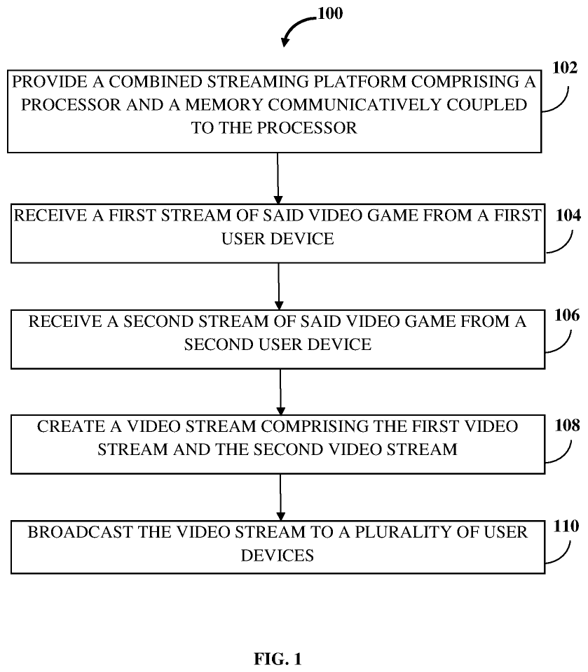

FIG. 1 illustrates a method of creating and broadcasting a video game stream. As used herein, “video game stream”, first stream, and second stream refer to a sequence of data elements made available over time, where data elements comprise one or more of audio and images representing a gameplay of the video game. The images when combined in sequence represents a video illustrating the gameplay of the video game. As used herein, “players”, “first player” and “second player” refers to video game players who stream their gameplay to a combined streaming platform. As used herein, “subscribers” refer to individuals who subscribe to services offered by the combined streaming platform and comprise both players who play a video game and viewers who watch the gameplay of the players. Also, as used herein, “VS mode” refers to a versus mode where the gameplays of the first and second players that are competing against each other in a video game are simultaneously broadcasted for display on one or more viewer devices.

The method 100 disclosed herein comprises providing 102 a combined streaming platform comprising a processor and a memory unit communicatively coupled to the processor. The memory unit comprises computer program instructions that when executed by the processor cause the computer to create and broadcast a video game stream comprising a first stream and a second stream. The combined streaming platform receives 104 the first stream of the video game from a first user device. The combined streaming platform receives 106 the second stream of the video game from a second user device. The first and second streams comprise one or more of audio and images representing a gameplay of the video game. The first user device is associated with a first player and the second user device is associated with a second player. The players, for example, video game players stream their gameplay of the video game to the combined streaming platform. The first and second user devices comprise computers, laptops, mobile phones, gaming consoles, handheld gaming consoles, etc. Examples of gaming consoles comprise Xbox® series of gaming consoles manufactured by Microsoft Corporation®, PlayStation® series of gaming consoles manufactured by Sony Corporation®, Stadia series of gaming console manufactured by Google etc. Examples of portable gaming consoles comprise Play Station Portable series of portable gaming consoles made by Sony Corporation®, Portable gaming consoles made by Nintendo®, etc.

Player v/s Player (PvP) games, for example, League of Legends, Fortnite Battle Royale, etc., allow at least one player to compete against another player in a video game environment by allowing the players to control characters in the game. Several video games which are not PvP games allow multiple players to simultaneously participate in the video game and compete against each other. The gameplay, for example, the first player's interaction with the gaming environment and characters in the video game is displayed on a display screen of the first user device. Similarly, the gameplay, i.e., the second player's interaction with the gaming environment and characters in the video game is displayed on a display screen of the first user device. The gameplay displayed on the display screen of the first user device constitutes the first stream of the video game from the first user device. Similarly, the gameplay displayed on the display screen of the second user device constitutes the second stream of the video game from the second user device. In an embodiment, the first stream also comprises audio generated by the video game that corresponds to the gameplay displayed on the display screen of the first user device, and the second stream also comprises audio generated by the video game corresponding to the gameplay displayed on the display screen of the second user device.

The combined streaming platform, on receiving the first stream of the video game and the second stream of the video game, creates 108 the video game stream comprising the first stream and the second stream. The video game stream is configured to be displayed on a user device for simultaneously displaying the first and second streams. The combined streaming platform broadcasts 110 the video game stream to one or more viewer devices. Examples of viewer devices comprise computers, laptops, mobile phones, and other internet connected devices having a display screen and an input interface.

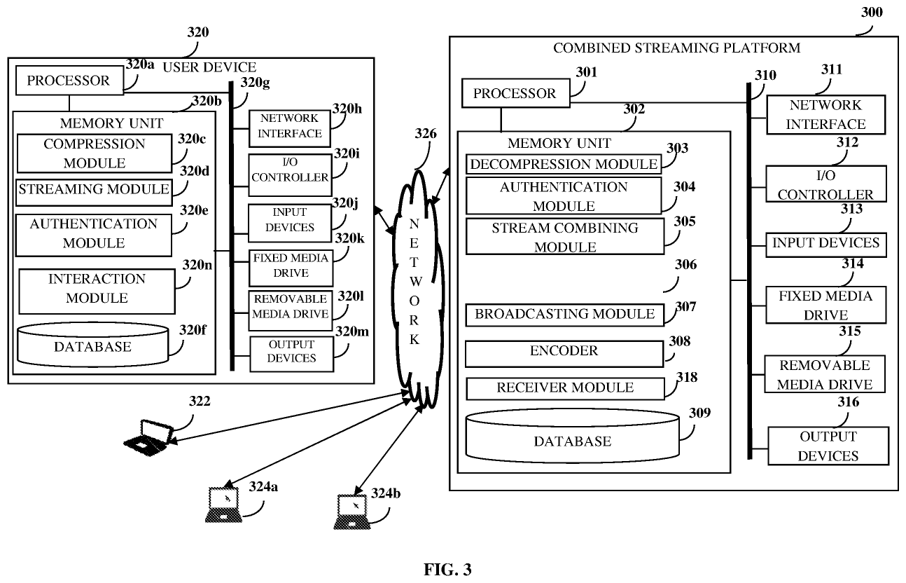

FIG. 3 exemplarily illustrates a combined streaming platform 300, first user device 320, second user device 322, and multiple viewer devices 324a and 324b. The first user device 320 comprises a processor 320a and a memory unit 320b. The memory unit 320b of the first user device 320 comprises a compression module 320c, a streaming module 320d, an authentication module 320e, and a database 320f. The compression module 320c is, for example, a compression software used to compress the first stream prior to transmission to the combined streaming platform 300. The compression software reduces the network bandwidth required to stream the first stream to the combined streaming platform 300. The streaming module 320d is for example a streaming software that streams the compressed first stream from the first user device 320 to the combined streaming platform 300 over a network 326. Examples of streaming software comprise Open Broadcaster Software (OBS), Streamlabs' Open Broadcast Software, etc. In an embodiment, the streaming software streams the first stream of the video game in real-time to the combined streaming platform 300. In an embodiment, the streaming software 320c streams the first stream to the combined streaming platform 300 in a HTTP Live Streaming (HLS) streaming protocol. In an embodiment, the streaming software 320c streams the first stream to the combined streaming platform 300 in other streaming protocols, for example, Real Time Messaging Protocol (RTMP), Dynamic Adaptive Streaming over HTTP (DASH), etc. In an embodiment, the streaming module 320c uses HLS (HTTP Live Streaming) encoding technique provided by a unified streaming media server software, for example, the Wowza Streaming Engine software developed by Wowza Media Systems of Golden Colarado, USA. The Wowza Streaming Engine software streams the first stream using HLS encoding to an RTMP protocol feed of the combined streaming platform 300. The combined streaming platform 300 encodes the first and second streams on and streams the broadcast of the video game stream to a member device 324a, 324b, and the first user device 320, and the second user device 322.

In an embodiment, the memory unit 320b of the first user device 320 further comprises an authentication module 320e for authenticating the first user. In an embodiment, the authentication module 320e authenticates the first user before allowing the first user to use the first user device 320. In another embodiment, the authentication module 320e is in communication with the combined streaming platform 300. The first user is a subscriber to the services offered by combined streaming platform 300 and the authentication module 320e authenticates the first user using login credentials of the first user and allows the first user to stream the first video to the first stream of the video game.

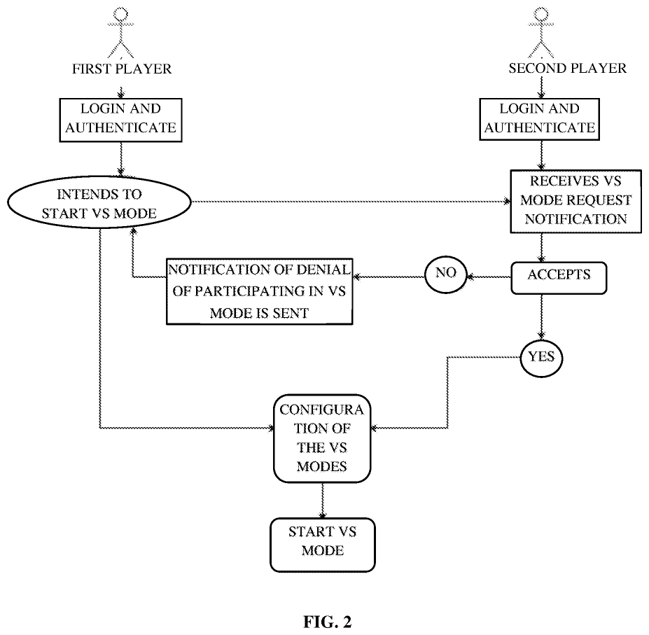

FIG. 2 exemplarily illustrates a flowchart showing steps involved in starting a VS mode comprising two players. As illustrated in FIG. 3, the first user device 320 comprises an authentication module 320e. Similarly, the combined streaming platform 300 also comprises an authentication module 304. The authentication module 304 stores authentication information of subscribers of the combined streaming platform 300 in a database 309 in the combined streaming platform 300. The authentication module 304 authenticates the subscribers of the combined streaming platform 300 in communication with the authentication module 320e of the first user device 320. The authentication module 320e of the first user device 320 sends authentication information provided by the first player to the combined streaming platform 300. The authentication module 304 authenticates the first player if the authentication information received from the first user device 320 matches the authentication information stored in the database 309.

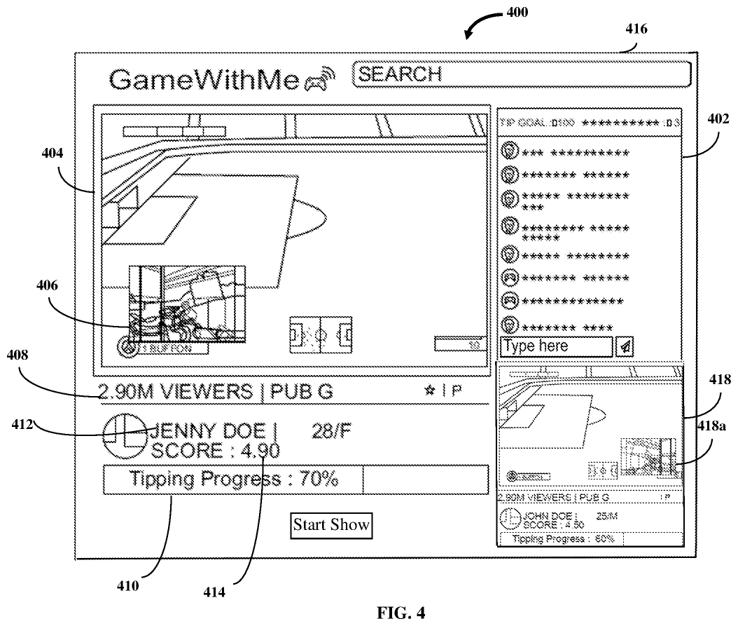

As illustrated in FIG. 2, to start the Versus (VS) mode, the first player and the second player login to the combined streaming platform 300 and are authenticated by the authentication module 304. If the first player intends to start a VS mode, the first player sends a request to the second player by pressing a button (not shown) on his interface 416. If there are multiple players, the first player can select one or more players from a menu (not shown) to start the VS mode. The selected players, for example, the second player, receives a notification requesting the second players to join a VS mode initiated by the first player. The notification comprises information of the game selected by the first player to play in the VS mode, and the percentage of a progressive pot that the winner will receive. If the second player denies the request, a notification of denial to participate in the VS mode is sent to the first player. If the second player accepts the request, the combined streaming platform 300 configures the first and second user devices 320 and 322 to start the VS mode. Configuration of the VS mode in the first and second user devices 320 and 322 comprises embedding the gameplay of the first and second user devices on a standard broadcasting screen 416, shown in FIG. 4. The standard broadcasting screen 416 will not be live until both the first and second players click a button labeled “Start Show”. Once both the first and second players click the “Start Show” button, the streaming screen 416 will have a smaller image 418 displaying the transmission stream or a transmission image 418a of the other player. The standard broadcasting screen 416 will also show a chat interface 402. The image and/or the video 406 of the first player is configured to be displayed proximal to the first stream 404 of the video game. The image and the video 418a of the second player is configured to be displayed proximal to the second stream 418 of the video game.

The memory unit 320b of the first user device 320 further comprises an interaction module 320n which when executed by the processor 320a provides the chat interface 402, illustrated in FIG. 4, on the first user device 320 for the first player to interact with one or more players and/or viewers simultaneously. The chat interface 402 allows the first player and second player to interact with the viewers in private mode. The viewers provide tips and gifts to the first player and the second player during broadcasting of the video game stream.

As illustrated in FIG. 3, the combined streaming platform 300 comprises a processor 301 and a memory unit 302 communicatively coupled to the processor 301. The memory unit 302 comprises a receiver module 318 for receiving the first stream and the second stream from the first user device 320 and second user device 322, respectively. The memory unit 302 comprises a decompression module 303 for decompressing the first stream and the second stream received from the first user device 320 and second user device 322. The memory unit 302 further comprises an encoder 308 for encoding the first and second streams. The memory unit 302 further comprises an interaction exchange module 306 to facilitate exchange of chat messages between chat interfaces 402 of the first and second user devices 320 and 322, and the viewer devices 324a and 324b. The memory unit 302 further comprises a stream combining module 305 for combining the encoded first and second streams and the chat messages to create the video game stream. The memory unit 302 further comprises a broadcasting module 307 to broadcast the video game stream to a viewer device 324a, 324b, and the first user device 320, and the second user device 322.

FIG. 4 illustrates a standard broadcast displayed on the first user device 320. In an embodiment, the gameplay of the video game played 404 by the first player in the first user device 320, the chat interface 402, an image or a video 406 of the first player, number of viewers 408 viewing the first stream of the first player, tips received 410 by the first player, name 412 of the first player, and score 414 obtained by the first player are all embedded in standard broadcast screen 416 and displayed on the display screen 400 of the first user device 320, as illustrated in FIG. 4.

The second user device 322 is functionally similar to the first user device 320 and comprises the same components, i.e., 320a-320m as the first user device 320. The second user device 322 is connected to the combined streaming platform 300 through the network 326. The gameplay of the video game played by the second player in the second user device 322, a chat interface, an image or a video of the second player, number of viewers viewing the second stream of the second player, tips received by the second player, name of the second player, and score obtained by the second player are all embedded in a single interface and displayed on a display screen of the second user device 322.

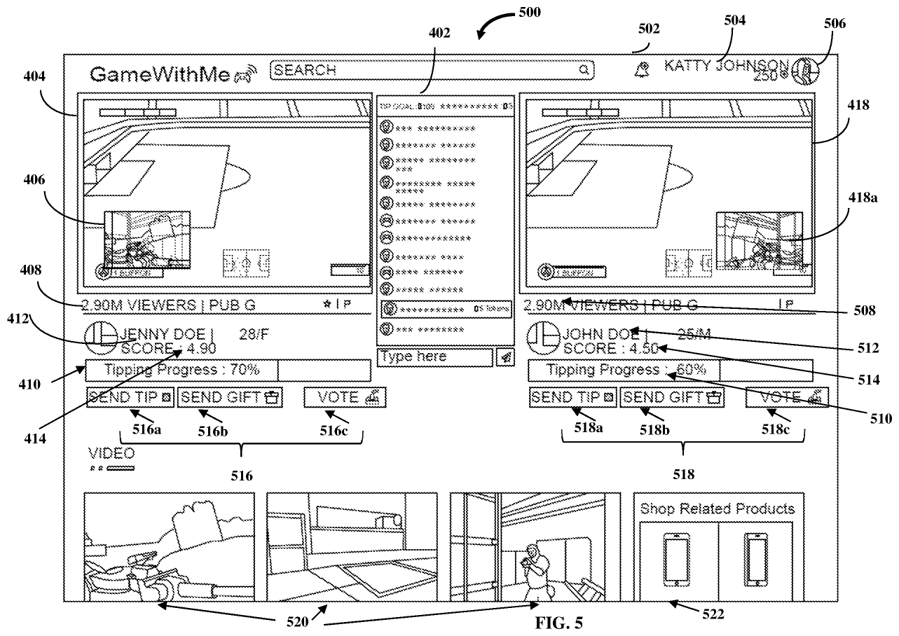

FIG. 5 illustrates a display screen 500 of a viewer's user device 324a, 324b showing the viewer broadcast 502 displayed to the viewers. In an embodiment, the viewer broadcast 502 is shown to both the first and second players instead of the standard broadcast illustrated in FIG. 4, in case the first player and the second player would like to see the first stream and the second stream of the video game in display windows 404 and 418 of same size. In an embodiment, the display windows 404 and 418a are resizable according to the player's or viewer's preference. As shown in FIG. 5, the viewer broadcast 502 displayed on a viewer's device 324 shows the gameplay of the video game played 404 and 418 by the first player in the first user device 320 and the second player in the second user device 322, the chat interface 402 which is common to the first and second players and the viewers, an image or a video 406 and 418a of the first player and the second player, number of viewers 408 and 508 viewing the first stream of the first player and the second stream of the second player, tips received 410 and 510 by the first player and of the second player, names 412 and 512 of the first player and the second player, and scores 414 and 514 obtained by the first player and the second player are all embedded in the viewer's broadcast screen 502 and displayed on the display screen 400 and 500 of the first user device 320, the second user device 322, and the viewer devices 324a and 324b.

A code snippet of the code used to create the video game stream comprising the first stream of the video game and the second stream of the video game is disclosed below:

<?php

namespace app\models;

use Yii;

/**

* This is the model class for table “{{% broadcast}}”.

*

* @property int $id

* @property int $member_id

* @property string $rtmp_link

* @property string $topic

* @property string $goal_type

* @property string $tip_goal_details

* @property string $show_type

* @property string $show_goal

* @property string $minimum_entry_prize

* @property string $notes

* @property string $status

* @property string $toc

* @property int $category_id

* @property string $activity_time

* @property int $created_at

* @property int $updated_at

*

* @property Member $member

//}

// if (!isset($difference)) {

// $difference=0;

//}

return $difference;

}

}

In an embodiment, the combined streaming platform 300 allows a person, for example, a viewer to provide commentary during the gameplay of the videogame through the interaction exchange module 306. For example, in tournament matches in the video game, a subscriber is appointed as a moderator. The moderator is assigned the role of a commentator. The commentator is allowed to input audio and video from the user device of the commentator to provide audio commentary and/or video commentary in real time. An image 506 of the commentator along with the name 504 of the commentator are displayed on the viewer's broadcast screen 502.

As illustrated in FIG. 5, the chat interface 402 further comprises controls 516 and 518 for sending tips and virtual gifts to the first and second player. For example, the controls 516 and 518 comprise send tip buttons 516a and 518a to send tips to the first payer and the second players, respectively; send gift buttons 516b and 518b to send gifts to the first and second players, respectively; and vote buttons 516c and 518c to cast a vote to either the first player or the second player. In an embodiment, the chat interface 402 is a Java based chat interface. In an embodiment, the first and second players monetize the broadcast of the video game stream. The viewers, for example, fans of the first player and/or second player vote for them in the form of monetized votes of about $1 each. In an embodiment, the first player and/or the second player select the percentage that the winner receives in for example, 25% increments, ranging from the winner receiving 50% to the winner taking all the collected monetized votes received by both the first player and the second player. In an embodiment, the viewer broadcast 502 displays pre-recorded gameplays 520 of the video game. In another embodiment, the viewer broadcast 502 displays advertisements 522.

A code snippet of the code used to start broadcasting of the video game stream by the broadcasting module 308 to multiple viewer devices 324a, 324b, and/or user devices 320 and 322, and the code snippet used to update live streaming on the viewer broadcast 502 is disclosed below:

jQuery(document).pjax(“#update-live-broadcast-performers-list-pjax a”,
{“push”:true,“replace”:false,“timeout”:1000,“scrollTo”:false,
“container”:“#update-live-broadcast-performers-list-pjax”});
jQuery(document).on(“submit”, “#update-live-broadcast-performers-list-
pjax form[data-pjax]”, function (event) {jQuery.pjax.submit(event,
{“push”:true,“replace”:false,“timeout”:1000,“scrollTo”:false,
“container”:“#update-live-broadcast-performers-list-pjax”});});

As exemplarily illustrated in FIG. 3, the combined streaming platform 300 and the first user device 320 further comprise data buses 320g and 310, network interfaces 320h and 311, input/output (I/O) controllers 320i and 312, input devices 320j and 313, fixed media drives 320k and 314 such as hard drives, removable media drives 3201 and 315 for receiving removable media, output devices 320m and 316, etc. The data bus 310 of the combined streaming platform 300 permits communication between the modules, for example, 303-308, etc., of the combined streaming platform 300. The data bus 320g of the first user device 320 permits communication between the modules, for example, 320c-320n, etc., of the first user device 320. The network interfaces 320h and 311 enable connection of the combined streaming platform 300 and the first user device 320 respectively, to the network 326. In an embodiment, the network interfaces 320h and 311 of the combined streaming platform 300 and the first user device 320 respectively, are provided as interface cards also referred to as “line cards”. The network interfaces 320h and 311 are, for example, one or more of infrared (IR) interfaces, interfaces implementing Wi-Fi® of Wi-Fi Alliance Corporation, universal serial bus (USB) interfaces, FireWire® interfaces of Apple Inc., Ethernet interfaces, frame relay interfaces, cable interfaces, digital subscriber line (DSL) interfaces, token ring interfaces, peripheral controller interconnect (PCI) interfaces, local area network (LAN) interfaces, wide area network (WAN) interfaces, interfaces using serial protocols, interfaces using parallel protocols, Ethernet communication interfaces, asynchronous transfer mode (ATM) interfaces, high speed serial interfaces (HSSIs), fiber distributed data interfaces (FDDIs), interfaces based on transmission control protocol (TCP)/internet protocol (IP), interfaces based on wireless communications technology such as satellite technology, radio frequency (RF) technology, near field communication, etc. The I/O controllers 320i and 312 control input actions and output actions performed by the combined streaming platform 300 and the first user device 320 respectively. The second user device 322 is functionally similar to the first user device 320 and comprises the same components, i.e., 320a-320m as the first user device 320.

It is apparent that in different embodiments, the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft® .NET, Objective-C®, etc. (Please verify the correctness of this highlighted section in the context of your invention.) Other object-oriented, functional, scripting, and/or logical programming languages can also be used. In an embodiment, the computer program codes or software programs are stored on or in one or more mediums as object code. In another embodiment, various aspects of the method and the combined streaming platform 300 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the method and the combined streaming platform 300 disclosed herein are implemented as programmed elements, or non-programmed elements, or any suitable combination thereof.

Where databases are described such as databases 320f and 309, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, notwithstanding any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the combined streaming platform 300, the databases are integrated to communicate with each other for enabling simultaneous updates of data linked across the databases, when there are any updates to the data in one of the databases.

The method and combined streaming platform 300 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The method and the combined streaming platform 300 disclosed herein are not limited to a particular computer system platform, processor, operating system, or network. In an embodiment, one or more aspects of the method and the combined streaming platform 300 disclosed herein are distributed among one or more computer systems, for example, servers configured to provide one or more services to one or more client computers, or to perform a complete task in a distributed system. For example, one or more aspects of the method and combined streaming platform 300 disclosed herein are performed on a client-server system that comprises components distributed among one or more server systems that perform multiple functions according to various embodiments. These components comprise, for example, executable, intermediate, or interpreted code, which communicate over a network using a communication protocol. The method and the combined streaming platform 300 disclosed herein are not limited to be executable on any particular system or group of systems, and are not limited to any particular distributed architecture, network, or communication protocol.

The foregoing examples have been provided merely for explanation and are in no way to be construed as limiting of the method and the combined streaming platform 300 disclosed herein. While the method and the combined streaming platform 300 have been described with reference to various embodiments, it is understood that the words, which have been used herein, are words of description and illustration, rather than words of limitation. Furthermore, although the method and combined streaming platform 300 have been described herein with reference to particular means, materials, and embodiments, the method and combined streaming platform 300 are not intended to be limited to the particulars disclosed herein; rather, the method and combined streaming platform 300 extend to all functionally equivalent structures, methods and uses, such as are within the scope of the appended claims. While multiple embodiments are disclosed, it will be understood by those skilled in the art, having the benefit of the teachings of this specification, that the method and combined streaming platform 300 disclosed herein are capable of modifications and other embodiments may be effected and changes may be made thereto, without departing from the scope and spirit of the method and combined streaming platform 300 disclosed herein.

I claim:

1. A method of creating and broadcasting a video game stream, comprising the steps of:
providing a combined streaming platform comprising a processor and a memory unit communicatively coupled to the processor, wherein the memory unit comprises computer program instructions that when executed by the processor cause the computer to perform steps comprising:
receiving a first stream of said video game from a first user device;
receiving a second stream of said video game from a second user device, wherein said first stream and second stream comprise one or more of audio and a plurality of images representing a gameplay of said video game;
creating a video game stream comprising the first stream of said video game and the second stream of said video game, wherein the video game stream is configured to be displayed on a viewer device for simultaneously displaying the first stream and second stream of said video game; and
broadcasting the video game stream to a plurality of viewer devices.

2. The method of claim 1, further comprising:
authenticating a first player associated with said first user device and a second player associated with said second user device;
receiving a request from said first player to play said video game in a versus mode;
sending an invite, by said first player to said second player, to join a co-opt stream for creating said video game stream; and
receiving a notification indicating acceptance of said sent request by said second player.

3. The method of claim 1, wherein each of the plurality of viewer devices are associated with a subscriber of the combined streaming platform, and wherein the method further comprises:
providing a chat interface with the broadcasted video game stream for display on the viewer devices, wherein a first player associated with said first user device, a second player associated with said second user device, and said subscribers interact with other subscribers through said chat interface, and wherein said chat interface further comprises controls for sending tips and virtual gifts to said first and second players, and wherein said chat interface further comprises controls for allowing said members to cast a vote to one of said first player and said second player.

4. The method of claim 1 further comprising providing a commentary interface to a moderator for receiving one or more of an audio commentary and a video commentary from the moderator.

5. The method of claim 1, wherein the broadcasted video game stream comprises one of an image and a video of the first player and the second player.

6. The method of claim 5, wherein one of the image and the video of the first player is configured to be displayed proximal to the first stream of said video game, and wherein one of the image and the video of the second player is configured to be displayed proximal to the second stream of said video game.

7. A combined streaming platform for creating and broadcasting a video game stream, comprising:
a memory unit comprising computer program instructions defined by modules of said combined streaming platform;
at least one processor communicatively coupled to said memory unit for executing said computer program instructions defined by said modules of said combined streaming platform, said modules of said combined streaming platform comprising:
a receiver module for receiving a first stream of said video game from a first user device;
said receiver module for receiving a second stream of said video game from a second user device, wherein said first and second streams comprise one or more of audio and a plurality of images representing a gameplay of said video game;
a stream combining module for creating a video game stream comprising the first stream of said video game and the second stream of said video game, wherein the video game stream is configured to be displayed on a viewer device for simultaneously displaying the first and second streams of said video game; and
a broadcasting module for broadcasting the video game stream to a plurality of viewer devices.

8. The combined streaming platform of claim 7, further comprises:
an authentication module for authenticating a first player associated with said first user device and a second player associated with said second user device.

9. The combined streaming platform of claim 7, wherein said modules of said combined streaming platform further comprise:
an interaction exchange module for providing a chat interface with the broadcasted video game stream for display on the viewer devices, wherein a first player associated with said first user device, a second player associated with said second user device, and said subscribers interact with other subscribers through said chat interface, and wherein said chat interface further comprises controls for sending tips and virtual gifts to said first and second players, and wherein said chat interface further comprises controls for allowing said members to cast a vote to one of said first player and said second player.

10. The combined streaming platform of claim 9, wherein the interaction exchange module provides a commentary interface to a moderator for receiving one or more of an audio commentary and a video commentary from the moderator.

11. The combined streaming platform of claim 7, wherein the broadcasted video game stream comprises one of an image and a video of the first player and the second player.

12. The combined streaming platform of claim 11, wherein one of the image and the video of the first player is configured to be displayed proximal to the first stream of said video game, and wherein one of the image and the video of the second player is configured to be displayed proximal to the second stream of said video game.

13. A non-transitory computer readable storage medium having embodied thereon, computer program codes comprising instructions executable by at least one processor for creating and broadcasting a video game stream, said computer program codes comprising:
a first computer program code for receiving a first stream of said video game from a first user device;
a second computer program code for receiving a second stream of said video game from a second user device, wherein said first and second streams comprise one or more of audio and a plurality of images representing a gameplay of said video game;
a third computer program code for creating a video game stream comprising the first stream of said video game and the second stream of said video game, wherein the video game stream is configured to be displayed on a viewer device for simultaneously displaying the first and second streams of said video game; and
a fourth computer program code for broadcasting the video game stream to a plurality of viewer devices.
